(19) United States
(12) Patent Application Publication
(10) Pub. No.: US 2021/0381824 A1
(43) Pub. Date: Dec. 9, 2021

(54) LIDAR SYSTEM AND MOTOR VEHICLE

(71) Applicant: Robert Bosch GmbH, Stuttgart (DE)

(72) Inventors: Annemarie HOLLECZEK, Stuttgart (DE); Mustafa KAMIL, Ludwigsburg (DE)

(21) Appl. No.: 17/286,370

(22) PCT Filed: Dec. 5, 2019
(86) PCT No.: PCT/EP2019/083810

§ 371 Date: Apr. 16, 2021

(30) Foreign Application Priority Data
Dec. 12, 2018 (DE) 10 2018 221 530.8

(51) Int. Cl. G01B 11/22; G01S 7/481; B60W 40/02

(52) U.S. Cl. CPC G01B 11/22; B60W 2420/52; B60W 40/02; G01S 7/4816

(57) ABSTRACT

A lidar system that is configured to scan an environment with a light beam in order to acquire depth information regarding the environment. The lidar system is additionally configured to acquire color information regarding the environment. Also described is a motor vehicle having a lidar system operatively connected to the motor vehicle.

### FIELD

The present invention relates to a lidar system that is configured to scan an environment with a light beam in order to acquire depth information regarding the environment.

The present invention further relates to a motor vehicle having such a lidar system, the lidar system being operatively connected to the motor vehicle.

### BACKGROUND INFORMATION

Lidar systems and motor vehicles of these kinds are conventional in principle. They have, for example, an avalanche photodiode, for example a single-photon avalanche diode (SPAD), as a photodetector or instead a silicon photomultiplier (SiPM) as a photodetector. The lidar system can have a laser source for emitting the light beam. The photodetector is arranged to receive the light beam reflected from the environment. An electronic evaluation system can then obtain the depth information from reception signals of the photodetector.

U.S. Patent Application Publication No. US 2017/176579 A describes, for example, a lidar system (“electro-optical device”) made up of a laser source, a beam deflector, a photodetector, optics, and corresponding electronics. This published application describes a system that successively activates detector pixels in order to increase the signal-to-noise ratio of a sensor. It is apparent to one skilled in the art from this teaching that this is a micromirror-based implementation of the lidar system. The detector units are, however, temporarily active in parallel, since the lidar system furnishes not a scanning illumination pattern but a uniform (“flash”) one.

U.S. Patent Application Publication No. US 2018/003821 A describes a lidar system (“object detector”) made up of several light sources, a photodetector, optics, and corresponding electronics. The light sources are individually and successively controllable laser diodes. U.S. Patent Application Publication No. US 2018/003821 A describes that each light source has exactly one reception element associated with it. The pixels are read out individually and simultaneously/concurrently. The detector type can be implemented as a SPAD, and this is described as a possible embodiment; but one skilled in the art sees in the illustrations a lidar system having avalanche photodiodes (APDs).

In addition, SPAD sensor systems having red, green, and blue (RGB) color channels, and having separate photodetectors, are conventional in principle.

U.S. Patent Application Publication No. US 2016/240579 A1 describes a “color-seeing” apparatus in which RGB pixels are connected to SPAD pixels to constitute one unit. RGB pixels and SPAD pixels are, however, read out individually and separately, and the data are combined only subsequently in the context of signal processing.

German Patent Publication No. DE 697 33 014 T2 is regarded as general related art, and describes a system that uses a lidar scanner. An additional narrow-angle CCD camera acquires texture data and color data. A standard RGB image of a scene can be displayed, and RGB export is possible.

German Patent Application No. DE 10 2016 211 013 A1 is regarded as general related art, and describes a lidar apparatus in which a detection device of the lidar apparatus has a color filter and/or bandpass filter. SPAD photodiodes are provided as detection surfaces.

German Patent Application No. DE 10 2006 010 295 A1 describes a camera system having at least two image sensors of different kinds, and is likewise regarded as general existing art. A CMOS image sensor is combined, for example, with a SPAD image sensor. The reliability of a 3D image that is assembled from the sensor data is enhanced by redundant imaging of an object (e.g. shape, size, color, etc.).

### SUMMARY

The present invention provides a lidar system, the lidar system additionally being configured to acquire color information regarding the environment.

The lidar system according to an example embodiment of the present invention may have the advantage that the lidar system is expanded to include the acquisition of color information regarding the environment. The lidar system thus simultaneously furnishes both a conventional lidar scanning function for acquiring depth information, and a passive color-image camera for acquiring color information. The predominant color properties of objects can be ascertained and correlated, preferably synchronously in time, with their distance. A passive color-image camera can be combined with a lidar mode in a single unit.

It is preferred that the lidar system be configured to constitute a color signal from reception signals of one or several photodetectors in order to acquire the color information regarding the environment. The one or several photodetectors are preferably additionally configured to acquire the depth information. Photodetectors are often present in any case in lidar systems in order to acquire the depth information, and can thus take on an additional function. Dual utilization of the photodetectors makes possible, for example, optimal time synchronization of color information and depth information. The lidar system is correspondingly preferably configured to acquire the color information and depth information synchronously, and preferably also to output it synchronously, preferably by way of the electronic evaluation system. The combination of depth acquisition and color acquisition in a single optical path is also thereby enabled, which can offer advantages, for instance, in terms of overall size. The lidar system is particularly preferably configured to constitute an assembled color signal from reception signals of several photodetectors in order to acquire the color information regarding the environment. A correspondingly configured electronic evaluation system can be provided for this purpose in the lidar system. The assembled color signal is preferably the RGB signal, particularly preferably an RGBIR signal which also includes infrared (IR) data along with red, green, and blue. Because the lidar system is thus already configured to constitute the assembled color signal, subsequent assembly of reception signals in order to constitute the assembled color signal in the context of an evaluation at a later time can be omitted. For the detection of object properties in the environment, three additional parameters are detected by the lidar system by way of the RGB signals. It is thereby possible, for example, to improve machine learning algorithms. Preferred photodetectors are semiconductor detectors, manufactured in particular from silicon, gallium arsenide, or indium phosphide. Use of the photodetectors to constitute the color signal can furthermore have the advantage that exposure times on the order of milliseconds, which usual commercially available color cameras require for color pixels, can be decreased to the order of nanoseconds.

In accordance with an example embodiment of the present invention, it is preferred that the lidar system have a first photodetector assemblage and a second photodetector assemblage. The first photodetector assemblage is preferably configured to receive a first light wavelength region. The first light wavelength region is preferably the light wavelength region of red light. The first light wavelength region is therefore located in particular between 585 nm and 780 nm. The first light wavelength region can also, however, deviate slightly upward or downward, or can also be specified at a predetermined value within the aforesaid interval, for example exactly 650 nm. The selectivity of the first photodetector assemblage can thereby be increased or decreased depending on the application. The second photodetector assemblage is preferably configured to receive a second light wavelength region. The second light wavelength region is preferably the light wavelength region of green light. The second light wavelength region is therefore located in particular between 497 nm and 585 nm. The second light wavelength region can also, however, deviate slightly upward or downward, or can also be specified at a predetermined value within the aforesaid interval, for example exactly 510 nm. The selectivity of the second photodetector assemblage can thereby be increased or decreased depending on the application. The first light wavelength region is preferably at least in part different from the second light wavelength region. In some embodiments of the present invention, provision is made that the first light wavelength region and the second light wavelength region overlap. In other embodiments of the present invention, provision is made that the first light wavelength region and the second light wavelength region are separated. The lidar system thus makes it possible to acquire two light wavelength regions that constitute different kinds of color information regarding the environment. In other words, in this embodiment the lidar system thus simultaneously furnishes both a conventional lidar scanning function for acquiring depth information and a two-color passive color-image camera for acquiring color information, namely for the first light wavelength region and for the second light wavelength region. This can result in decreasing costs, decreasing overall size, and elimination of outlay for alignment and calibration.

In certain embodiments, the lidar system in accordance with the present invention, has a third photodetector assemblage. It is preferred that the third photodetector assemblage be configured to receive a third light wavelength region. The third light wavelength region is preferably the light wavelength region of blue light. The third light wavelength region is therefore located in particular between 380 nm and 497 nm. The third light wavelength region can also, however, deviate slightly upward or downward, or can also be specified at a predetermined value within the aforesaid interval, for example exactly 490 nm. The selectivity of the third photodetector assemblage can thereby be increased or decreased depending on the application. In some embodiments, the third light wavelength region is at least in part different from the first light wavelength region. In certain embodiments, the third light wavelength region is at least in part different from the second light wavelength region. Some embodiments provide, however, that the third wavelength region and the second light wavelength region overlap. If three light wavelength regions are provided for acquisition, a three-color color signal, in particular the RGB signal, can be furnished in simple fashion by the lidar system. In some embodiments of the present invention, the three-color color signal can be furnished by the lidar system via three separate color channels, each of which furnishes one of the three color signals.

In certain embodiments the lidar system in accordance with the present invention has a fourth photodetector assemblage. The fourth photodetector assemblage is preferably configured to receive a fourth light wavelength region. The fourth light wavelength region is preferably the light wavelength region of IR light. The first light wavelength region is therefore located in particular between 700 nm and 1 mm. The fourth light wavelength region can also, however, deviate slightly upward or downward, or can also be specified at a predetermined value within the aforesaid interval, for example exactly 780 nm. The selectivity of the fourth photodetector assemblage can thereby be increased or decreased depending on the application. In some embodiments, the fourth light wavelength region is located in the region of the near infrared (NIR) and/or middle infrared (MIR) and/or far infrared (FIR). It is preferred that the fourth light wavelength region be at least in part different from the first light wavelength region. It is further preferred that the fourth light wavelength region be at least in part different from the second light wavelength region. It is likewise preferred that the fourth light wavelength region be at least in part different from the third light wavelength region. In some embodiments of the present invention, the first light wavelength region and the fourth light wavelength region overlap. In certain embodiments of the present invention, however, the first light wavelength region and the fourth light wavelength region are separated from one another. If the lidar system provides the four photodetector assemblages, a four-color color signal, in particular the RGBIR signal, can be furnished in simple fashion by the lidar system. The four color signals can be furnished by the lidar system via four separate color channels, each of which furnishes one of the four color signals.

Preferably the first photodetector assemblage furnishes the red signal. Preferably the second photodetector assemblage furnishes the green signal. Preferably the third photodetector assemblage furnishes the blue signal. Preferably the fourth photodetector assemblage furnishes the IR signal. In some embodiments, however, the first photodetector assemblage can furnish both the red signal and the IR signal in combination. The first light wavelength region is then located, in particular, between 585 nm and 1 mm. A red signal, green signal, blue signal, and IR signal can thus be furnished using only three photodetector assemblages, preferably via only three color channels.

In some embodiments of the present invention, two or more of the photodetector assemblages are disposed in one conjoint detector matrix. It is preferred that two or more of the photodetector assemblages constitute one conjoint detector component. This has the advantage that the outlay for alignment and configuration can decrease, since it is no longer necessary to configure individual photodetector assemblages in relation to one another before initial operation, but instead two of the more several photodetector assemblages can be furnished as a preconfigured conjoint component. It is particularly preferred that all photodetector assemblages be disposed in the conjoint detector matrix and constitute one conjoint detector component. The detector matrix preferably has rows and columns, the number of rows preferably being identical to the number of columns. Preferably three or more rows and/or three or more columns are present, particularly preferably four or more rows and/or four or more columns, very particularly preferably more than five or more rows and/or five or more columns.

In accordance with an example embodiment of the present invention, it is preferred that each of the photodetectors be associated with exactly one of the photodetector assemblages. It is furthermore preferred that in the detector matrix, photodetectors adjacent to one another in a row and/or column be associated with different photodetector assemblages. Preferably, in each row of the detector matrix several, particular preferably exactly two, of the photodetector assemblages are alternately interleaved with one another. Each of the photodetectors preferably has upstream from it a light wavelength filter that is transparent to the light wavelength region that is to be received by the respective photodetector assemblage. The light wavelength filter that is respectively upstream from the photodetectors of the first photodetector assemblage is preferably transparent to the first light wavelength region. The light wavelength filter that is respectively upstream from the photodetectors of the second photodetector assemblage is preferably transparent to the second light wavelength region. The light wavelength filter that is respectively upstream from the photodetectors of the third photodetector assemblage is preferably transparent to the third light wavelength region. The light wavelength filter that is respectively upstream from the photodetectors of the fourth photodetector assemblage is preferably transparent to the fourth light wavelength region. In other words, the association of the photodetectors with the respective photodetector assemblages is determined by the respective upstream light wavelength filter. The number of different light wavelength filters determines the number of photodetector assemblages. Thus if, for example, a plurality of light wavelength filters are provided which overall are transparent to three different light wavelengths, three photodetector assemblages are then defined thereby. The advantage thereof can be that the photodetectors themselves can all be embodied identically, in particular in terms of the light wavelength receivable by them, and only the respective upstream light wavelength filter determines which light wavelength region is detected by the photodetector located behind it. Alternatively, however, the photodetectors themselves can be configured to be wavelength-selective, so that the light wavelength filters upstream in a detection direction can be omitted. All the photodetectors that have the same wavelength selectivity can then constitute a respective photodetector assemblage that is defined by its respective wavelength selectivity.

In accordance with an example embodiment of the present invention, it is preferred that several of the light wavelength filters be disposed in one conjoint filter matrix and constitute one conjoint filter component. In other words, the filter matrix is placed in the optical reception path upstream from a SPAD-based detector in an SiPM configuration (SPAD array). Particularly preferably, a conformation of the filter matrix corresponds to a conformation of the detector matrix, so that one of the light wavelength filters is respectively upstream from one of the photodetectors. This has the advantage that the outlay for alignment and configuration can decrease, since it is no longer necessary to configure individual light wavelength filters in relation to one another before initial operation, but instead two or more light wavelength filters can be furnished as a preconfigured conjoint component. It is particularly preferred that all the light wavelength filters be disposed in the conjoint filter matrix and constitute one conjoint filter component. Preferably the filter matrix has rows and columns, the number of rows preferably being equal to the number of columns. Preferably three or more rows and/or three or more columns are present, particularly preferably four or more rows and/or four or more columns, very particularly preferably more than five or more rows and/or five or more columns. Preferably, the number of rows and columns of the filter matrix corresponds to the number of rows and columns of the detector matrix. Exact coverage of the photodiodes with the respective light wavelength filters can thereby be achieved in particularly simple fashion, in order to define the various photodetector assemblages. A preferred filter matrix is correspondingly an RGBIR color field array or a modified Bayer filter. The light wavelength filters can preferably be produced from organic dyes or from coated Bragg filter structures. The present invention thus permits the use of inexpensive narrow-band optical wavelength filter arrays.

At least one of the photodetectors is preferably a single-photon avalanche photodiode. Single-photon avalanche photodiodes of this kind are configured to count individual photons, regardless of their light wavelength. This simplifies the design of the lidar system, since because of the light wavelength filters that are preferably upstream from the photodetectors, the photodetectors do not themselves need to filter the light wavelength, but instead only need to count the already-filtered photons. This permits the use of a plurality of identical photodetectors, and thus permits an inexpensive solution. It is therefore particularly preferred that all the photodetectors be single-photon avalanche photodiodes. In other words, the individual SPADs can count only photons. But because the individual light wavelength filters of the filter matrix transmit only photons of the correct frequency or wavelength, individual SPADs located behind them count specifically those photons that can then be associated with the colors or with the IR channel. It is preferred that both the depth information and the color information be obtained from the reception signal of the single-photon avalanche photodiode. The single-photon avalanche photodiode can thus perform a dual function, preferably with a considerable reduction in exposure times as compared with current color cameras.

In accordance with an example embodiment of the present invention, it is preferred that the detector component and the filter component form one conjoint constituent. For example, the filter component and the detector component can be produced in highly integrated fashion in a continuous clean-room process, and can be assembled to yield the conjoint constituent. Subsequent alignment outlay can thereby be eliminated. The detector component and the filter component are preferably intermaterially connected, in particular adhesively bonded, to one another in order to form the conjoint constituent. This can be a simple, inexpensive, and efficient capability for producing the conjoint constituent. In some embodiments of the present invention, the photodetectors are each individually encapsulated in an interior space that is constituted between the filter component and detector component. Each photodetector on the detector component can thereby be well protected separately. In some example embodiments of the present invention, however, provision is made that several photodetectors are encapsulated in one conjoint interior space.

In certain embodiments of the present invention, one or several of the photodetector assemblages encompass exactly one photodetector. In some embodiments of the present invention, one or several of the photodetector assemblages encompass two or more photodetectors. The number of photodetectors is preferably the same for two or more, or for all, of the photodetector assemblages. In certain embodiments, however, the number of photodetectors in the photodetector assemblage that furnishes the IR signal is less than or greater than in the other photodetector assemblages, the number of photodetectors in the other photodetector assemblages preferably being the same.

The present invention furthermore provides a motor vehicle, an embodiment of the lidar system described above being operatively connected to the motor vehicle.

The motor vehicle according to the present invention has the advantage that thanks to the lidar system, it is enhanced to include the acquisition of color information regarding the environment. The lidar system thus simultaneously furnishes on the motor vehicle both a conventional lidar scanning function for acquiring depth information and a passive color-image camera for acquiring color information. The predominant color properties of objects can be ascertained and, preferably synchronously in time, correlated with their distance. A passive color-image camera can be combined in a single device with a lidar mode.

Preferred motor vehicles are passenger cars, commercial vehicles, two-wheeled vehicles, in particular motorcycles, and buses. In the motor vehicle, the lidar system can be operatively connected via a suitable interface to control units for at least partly automated driving functions, in particular for mono/video partly automated driving. The motor vehicle can furthermore have 3D cameras.

Advantageous refinements of the present invention are disclosed herein.

### BRIEF DESCRIPTION OF THE DRAWINGS

Exemplifying embodiments of the present invention are explained in further detail with reference to the description below and to the figures.

FIG. 1 shows a lidar system in accordance with a first embodiment of the present invention, having one conjoint detector matrix and one conjoint filter matrix that is upstream from the detector matrix.

FIG. 2 is a schematic plan view of a conjoint detector component of the lidar system in accordance with the first embodiment of the present invention.

FIG. 3 is a lateral section view through the detector matrix and the filter matrix in accordance with FIG. 1.

FIG. 4 is a plan view of an alternative filter matrix in accordance with a second embodiment of the present invention.

### DETAILED DESCRIPTION OF EXAMPLE EMBODIMENTS

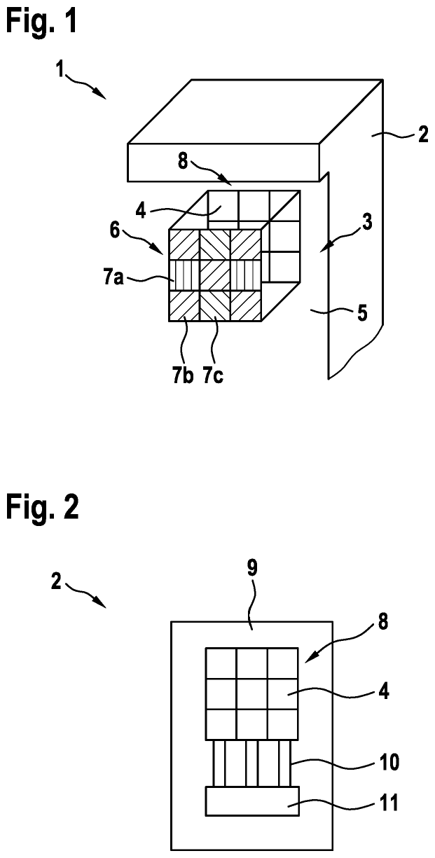

FIG. 1 shows a lidar system 1 in a first embodiment in accordance with the present invention. Lidar system 1 is disposed in a motor vehicle (not shown) and is operatively connected to the motor vehicle. Various details of lidar system 1 which are conventional, for example a laser source that serves to emit a light beam in order to scan an environment, have been omitted in the interest of simplification.

Lidar system 1 depicted in FIG. 1 is configured to scan the environment with a light beam in order to acquire depth information about the environment and is additionally configured to acquire color information regarding the environment, as will be explained in detail below.

Lidar system 1 encompasses a detector component 2 and a filter component 3. Detector component 2 encompasses a plurality of photodetectors 4, here (by way of example) nine identical photodetectors 4. Lidar system 1 is configured to acquire, by way of photodetectors 4, color information regarding the environment.

More precisely, lidar system 1 is configured to constitute a color signal from reception signals of the plurality of photodetectors 4 in order to acquire the color information regarding the environment.

In the first exemplifying embodiment which is shown, the individual photodetectors 4 are grouped into three photodetector assemblages that are defined by filter component 3 which is upstream from detector component 2 in a detection direction of photodetectors 4. Filter component 3 encompasses a filter frame 5 and a filter matrix 6 having (in this case once again nine) light wavelength filters 7a to 7c, of which three in each case are identical, i.e., three in each case allow the same light wavelength to pass. Filter matrix 6 is embodied as a checkerboard-like modified Bayer filter. Light wavelength filters 7a to 7c that each allow different light wavelengths to pass are disposed adjacently to one another.

Photodetectors 4 are single-photon avalanche diodes and are all embodied identically, i.e., they can only count individual photons regardless of their light wavelengths. The affiliation of photodetectors 4 with a respective photodetector assemblage results only from the light wavelength region for which light wavelength filter 7a-c of filter matrix 6, which is upstream from the respective photodetector 4, is transparent.

In the exemplifying embodiment shown, detector component 2 thus encompasses one conjoint 3×3 detector matrix 8 having nine identical individual photodetectors 4. Filter component 3 encompasses 3×3 filter matrix 6 having three red filters 7a that allow only red light, constituting a first light wavelength region, to pass; three green filters 7b that allow only green light, constituting a second light wavelength region, to pass; and three blue filters 7c that each allow only blue light, constituting a third light wavelength region, to pass. The first light wavelength region, the second light wavelength region, and the third light wavelength region are thus different from one another.

Photodetectors 4 that are disposed behind the three red filters 7a constitute the first photodetector assemblage, the first photodetector assemblage being configured, as a result of the upstream red filters 7a, to receive the first light wavelength region, namely that of red light. The three red filters 7a thus define the first photodetector assemblage, which is made up here of three identical single-photon avalanche diodes.

Photodetectors 4 that are disposed behind the three green filters 7b constitute the second photodetector assemblage, the second photodetector assemblage being configured, as a result of the upstream green filters 7b, to receive the second light wavelength region, namely that of green light. The three green filters 7b thus define the second photodetector assemblage, which is made up here of three further identical single-photon avalanche diodes.

Photodetectors 4 that are disposed behind the three blue filters 7c constitute the third photodetector assemblage, the third photodetector assemblage being configured, as a result of the upstream blue filters 7c, to receive the third light wavelength region, namely that of blue light. The three blue filters 7c thus define the third photodetector assemblage, which is made up here of three further identical single-photon avalanche diodes.

Each of the nine photodetectors 4 is, thus, associated with exactly one of the photodetector assemblages, each of photodetectors 4 having upstream from it a light wavelength filter 7a to 7c that is transparent to the light wavelength region, namely red light, green light, or blue light, that is to be received by the respective photodetector assemblage. This means that a conformation of filter matrix 6 corresponds to a conformation of detector matrix 8, so that one of light wavelength filters 7a to 7c is respectively upstream from one of photodetectors 4.

In other words, FIG. 1 shows a first configuration according to the present invention which provides for detector matrix 8 an SiPM constellation made up of several interconnected SPAD detectors constituting photodetectors 4, in this case e.g. as 3×3 “macropixels.” Filter matrix 6 is inserted in front of this detector matrix in the optical reception path of lidar system 1, so that each SPAD can count only photons of a selected light wavelength determined by the respective upstream light wavelength filter 7a to 7c. In embodiments that are not shown, red filter 7a can also be embodied as a combined red and infrared filter that allows only red light and infrared light to pass.

FIG. 2 is a plan view of detector component 2. Detector component 2 encompasses 3×3 detector matrix 8 that is made up of nine identical photodetectors, and a carrier plate 9 that carries detector matrix 8. Without a knowledge of filter matrix 6 it is therefore not apparent which of the nine identical photodetectors 4 is associated with which photodetector assemblage. In other words, this means that replacing filter matrix 6 also allows the association of photodetectors 4 to be modified.

Each photodetector 4 is connected via an electronic conductor-path assemblage 10 to an electronic evaluation system 11 constituted, for example, by an integrated evaluation control circuit. Electronic evaluation system 11 is configured to constitute a color signal from reception signals of photodetectors 4 in order to acquire color information regarding the environment. Based on a stored association table, electronic evaluation system 11 knows the association of the individual photodetectors 4 of detector matrix 8 with the (in this case, three) different photodetector assemblages, and can thus, for instance, evaluate a count signal of a photodetector 4, upstream from which is a red filter 7a, as a reception signal from the first photodetector assemblage and thus as a red signal. In the first exemplifying embodiment, electronic evaluation system 11 is configured to combine the reception signals of all photodetectors 4 and output them as a conjoint RGB color signal. At the same time, electronic evaluation system 11 is configured to obtain, from the reception signals of photodetectors 4, depth information regarding the environment. Each photodetector 4 thus has a dual function.

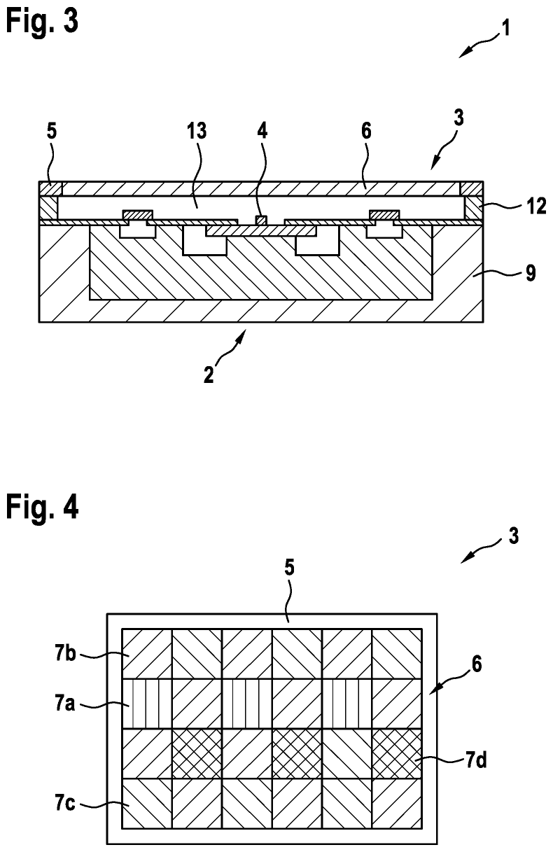

FIG. 3 is a lateral cross-sectional view through detector component 2 and filter component 3. Filter component 3 that has filter matrix 6 is intermaterially connected to detector component 2 that has detector matrix 8. For that purpose, filter component 3 is adhesively bonded to detector component 2 at a connecting point 12 in an edge region. Detector component 2 and filter component 3 are thus permanently connected to one another. Detector component 2 and filter component 3 thus form one conjoint constituent. Photodetectors 4 are encapsulated in an interior space 13 that is constituted between detector component 2 and filter component 3. The individual photodetectors 4 are thus protected from external environmental influences, for instance moisture. In the exemplifying embodiment shown, one photodetector 4 is respectively encapsulated individually in interior space 13. In other words, FIG. 3 is a sectioned illustration of an individual SPAD, i.e. photodetector 4, to depict the seamless attachment of a filter matrix 6 to the semiconductor diode (photodetector 4) in a clean-room process, for instance with the aid of intermaterial adhesive joins. An encapsulated conjoint constituent made up of detector component 2 and filter component 3 is thus created.

FIG. 4 is a plan view of an alternative filter matrix 6 in accordance with a second embodiment of the present invention. Filter matrix 6 is again embodied as a Bayer filter. In contrast to the first embodiment, filter matrix 6, which again is disposed in filter frame 5, is a 4×5 filter matrix 6 having four rows and five columns, i.e. twenty light wavelength filters 7a to 7d. Not shown is the fact that detector matrix 8 in the second embodiment of lidar system 1 correspondingly has twenty identical detectors 4 in a 4×5 detector matrix 8, so that the conformation of filter matrix 6 again corresponds to the conformation of detector matrix 8, and a light wavelength filter 7a to 7d of filter matrix 6 is respectively upstream (in a receiving direction) from a photodetector 4 of detector matrix 8. Here not just three but instead four different light wavelength filters 7a to 7d are furnished, each of which allows one light wavelength region to pass.

Lidar system 1 having the alternative filter matrix 6 of FIG. 4 thereby encompasses an additional, fourth photodetector assemblage that is configured to receive a fourth light wavelength region, namely infrared light. Specifically, fourth light wavelength filter 7d is an infrared filter that allows only infrared light to pass. The fourth light wavelength region is therefore different from the first, second, and third wavelength regions, which in this exemplifying embodiment are once again red light, green light, and blue light. Photodetectors 4 that are disposed behind the three infrared filters 7d constitute the fourth photodetector assemblage, the fourth photodetector assemblage being configured, as a result of the upstream infrared filter 7d, to receive the fourth light wavelength region, namely that of infrared light. The three infrared filters 7d thus define the fourth photodetector assemblage, which is thus made up here of three of the identical single-photon avalanche photodiodes. As is apparent from FIG. 4, the number of photodetectors 4 in the fourth photodetector assemblage is less than the number of photodetectors 4 in each of the other three photodetector assemblages in the second exemplifying embodiment. A red filter 7a, a green filter 7b, a blue filter 7c, and an infrared filter 7d are labeled with reference characters by way of illustration in FIG. 4. The respective cross-hatching respectively indicates further light wavelength filters 7a to 7d which each allow the same light wavelengths to pass but which do not have reference characters in the interest of clarity.

The result is to furnish a lidar system 1 and a motor vehicle that is operatively connected to lidar system 1, lidar system 1 being configured to scan an environment with a light beam in order to acquire depth information regarding the environment, lidar system 1 being additionally configured to acquire color information regarding the environment. In the approach shown, photodetectors 4 each have a light wavelength filter 7a to 7d upstream from them, so that photodetectors 4 are configured not only to count photons but also to selectively receive color information. Electronic evaluation system 11 can then evaluate both the color information and the depth information and can output, for example, an RGB signal or an RGBIR signal that is obtained by photodetectors 4. In other words, lidar system 1 thus furnishes simultaneously both a conventional lidar scanning function for acquiring depth information and a passive color-image camera for acquiring color information.

1-10. (canceled)

11. A lidar system configured to scan an environment with a light beam to acquire depth information regarding the environment, wherein the lidar system is additionally configured to acquire color information regarding the environment.

12. The lidar system as recited in claim 11, wherein the lidar system is configured to constitute a color signal from reception signals of one or several photodetectors to acquire the color information regarding the environment.

13. The lidar system as recited in claim 12, wherein the lidar system comprises:
a first photodetector assemblage; and
a second photodetector assemblage;
wherein the first photodetector assemblage is configured to receive a first light wavelength region and the second photodetector assemblage is configured to receive a second light wavelength region, the first light wavelength region being at least in part different from the second light wavelength region.

14. The lidar system as recited in claim 13, wherein the lidar system further comprises:
a third photodetector assemblage, the third photodetector assemblage being configured to receive a third light wavelength region, the third light wavelength region being at least in part different from the first light wavelength region and being at least in part different from the second light wavelength region.

15. The lidar system as recited in claim 14, wherein the lidar system further comprising:
a fourth photodetector assemblage, the fourth photodetector assemblage being configured to receive a fourth light wavelength region, the fourth light wavelength region being at least in part different from the first light wavelength region, and being at least in part different from the second light wavelength region, and being at least in part different from the third wavelength region.

16. The lidar system as recited in claim 13, wherein the first and the second photodetector assemblages are disposed together in one conjoint detector matrix and constitute one conjoint detector component.

17. The lidar system as recited in claim 13, wherein the one or several photodetectors include a plurality of photodetectors, each of the photodetectors being respectively associated with exactly one of the first and second photodetector assemblages and each photodetector of the photodetectors has upstream from it a light wavelength filter that is transparent to a light wavelength region that is to be received by the respective one of the first and second photodetector assemblage.

18. The lidar system as recited in claim 17, wherein the first and the second photodetector assemblages are disposed together in one conjoint detector matrix and constitute one conjoint detector component, and wherein several of the light wavelength filters are disposed together in one conjoint filter matrix and constitute one conjoint filter component, a conformation of the filter matrix corresponding to a conformation of the detector matrix, so that one light wavelength filter is respectively upstream from one photodetector.

19. The lidar system as recited in claim 12, wherein at least one of the photodetectors is a single-photon avalanche photodiode from whose reception signal both the depth information and the color information is obtained.

20. A motor vehicle, comprising:
a lidar system operatively connected to the motor vehicle;
wherein the lidar system is configured to scan an environment with a light beam to acquire depth information regarding the environment, and wherein the lidar system is additionally configured to acquire color information regarding the environment.
